(19) United States
(12) Patent Application Publication
(10) Pub. No.: US 2011/0234769 A1
(43) Pub. Date: Sep. 29, 2011

(54) APPARATUS AND METHOD FOR DISPLAYING IMAGES IN IMAGE SYSTEM

(75) Inventors: Gun BANG, Daejeon (KR); Won-Sik CHEONG, Daejeon (KR); Gi-Mun UM, Daejeon (KR); Namho HUR, Daejeon (KR); Hong-Chang SHIN, Seoul (KR); Jin-Woong KIM, Daejeon (KR); Soo-In LEE, Daejeon (KR)

(73) Assignee: Electronics and Telecommunications Research Institute, Daejeon (KR)

(21) Appl. No.: 13/070,146

(22) Filed: Mar. 23, 2011

(30) Foreign Application Priority Data
Mar. 23, 2010 (KR) 10-2010-0025906

(51) Int. Cl. H04N 13/04; H04N 7/26

(52) U.S. Cl. 348/51; 375/240.01; 348/E13.075; 375/E07.2

(57) ABSTRACT

An apparatus for displaying images in an image system includes: an encoder configured to encode color and depth images of at least one view received from a plurality of imaging devices and generate a reference image by synthesizing the encoded depth image of a current view and the encoded color and depth images before and after the current view based on a predetermined method; a decoder configured to decode a color image of the current view by using the generated reference image and decode the encoded color and depth images of at least one view; and a splitter configured to divide and split, based on each view, the decoded color and depth images of at least one view.

### CROSS-REFERENCE TO RELATED APPLICATIONS

The present application claims priority of Korean Patent Application No. 10-2010-0025906, filed on Mar. 23, 2010, which is incorporated herein by reference in its entirety.

### BACKGROUND OF THE INVENTION

1. Field of the Invention

Exemplary embodiments of the present invention relate to an apparatus and a method for displaying images; and, more particularly, to an apparatus and a method for displaying images in an image system.

2. Description of Related Art

User demands are shifting, in terms of displays, from services simply based on high-quality 2D image media to those for providing more realistic 3D displays. Such a shift is followed by research in various fields, including technologies for coding stereo-view/multi-view images. Stereo-view display systems are based on technology utilizing the human visual system, specifically binocular disparity, and simultaneously display images taken from at least two viewpoints so that users can feel depth perception from the images.

Multi-view image display systems display images, which look different at different locations, i.e. users are given some degree of freedom regarding the viewpoint, so that users can enjoy more stereoscopic and realistic images. In the case of conventional moving image encoding, the encoding efficiency is improved by removing time redundancy between frames. In the case of stereo-view moving image encoding, space redundancy between two views is also considered to improve the encoding efficiency. Research for removing such space redundancy between views is being conducted extensively by a research group dedicated to stereo-view/multi-view encoding and decoding, and so is standardization thereof.

Such research regarding multi-view video or free-view video is directed to a method for encoding not only conventional images, but also depth information of the images, through FTV standardization. As used herein, a conventional image refers to an image based on two axes (x and y), i.e. information obtained by projecting 3D space onto x-y plane. Addition of depth information gives full information regarding 3D space, making it possible to reconstruct 3D space from mathematically defined information.

As mentioned above, an image of a specific view among multi-view images can be properly estimated using color and depth images of peripheral views. Such an estimated image, if used as a reference image during encoding, can improve encoding efficiency.

### SUMMARY OF THE INVENTION

An embodiment of the present invention is directed to an apparatus and a method for displaying images, which can encode 2D and 3D images.

Another embodiment of the present invention is directed to an apparatus and a method for displaying images, which synthesize color and depth images of peripheral views and a depth image of the current view and use the synthesized image as a reference image during encoding of a color image of the current view.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an apparatus for displaying images in an image system includes: an encoder configured to encode color and depth images of at least one view received from a plurality of imaging devices and generate a reference image by synthesizing the encoded depth image of a current view and the encoded color and depth images before and after the current view based on a predetermined method; a decoder configured to decode a color image of the current view by using the generated reference image and decode the encoded color and depth images of at least one view; and a splitter configured to divide and split, based on each view, the decoded color and depth images of at least one view.

The apparatus may further include a first display unit configured to receive and display the split color image; a second display unit configured to render the split color and depth images in a predetermined scheme and display the rendered images; and a third display unit configured to render the slit color and depth images of at least one view in a predetermined scheme and display the rendered images.

In accordance with another embodiment of the present invention, a method for displaying images in an image system includes: encoding color and depth images of at least one view received from a plurality of imaging devices; generating a reference image by synthesizing the encoded depth image of a current view and the encoded color and depth images before and after the current view based on a predetermined method; decoding a color image of the current view by using the generated reference image and decoding the encoded color and depth images of at least one view; and dividing and splitting, based on each view, the decoded color and depth images of at least one view.

The method may further include: receiving and displaying the split color image; rendering the split color and depth images in a predetermined scheme and displaying the rendered images; and rendering the slit color and depth images of at least one view in a predetermined scheme and displaying the rendered images.

### BRIEF DESCRIPTION OF THE DRAWINGS

FIG. 1 illustrates the structure of an image display apparatus in an image system in accordance with an embodiment of the present invention.

FIG. 2 illustrates the structure of an image display apparatus in an image system in accordance with another embodiment of the present invention.

FIG. 3 illustrates the structure of an image display apparatus in an image system in accordance with still another embodiment of the present invention.

FIG. 4 illustrates the internal structure of a MVD encoder and a MVD decoder of an image display apparatus in an image system in accordance with an embodiment of the present invention.

FIG. 5 illustrates the internal structure of a MVD encoder and a MVD decoder of an image display apparatus in an image system in accordance with another embodiment of the present invention.

FIG. 6 illustrates a reference structure during encoding based on the embodiment of FIG. 4 by a MVD encoder of an image display apparatus in an image system in accordance with an embodiment of the present invention.

FIG. 7 illustrates a reference structure during encoding based on the embodiment of FIG. 5 by a MVD encoder of an image display apparatus in an image system in accordance with an embodiment of the present invention.

FIG. 8 illustrates an image display process in an image system in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

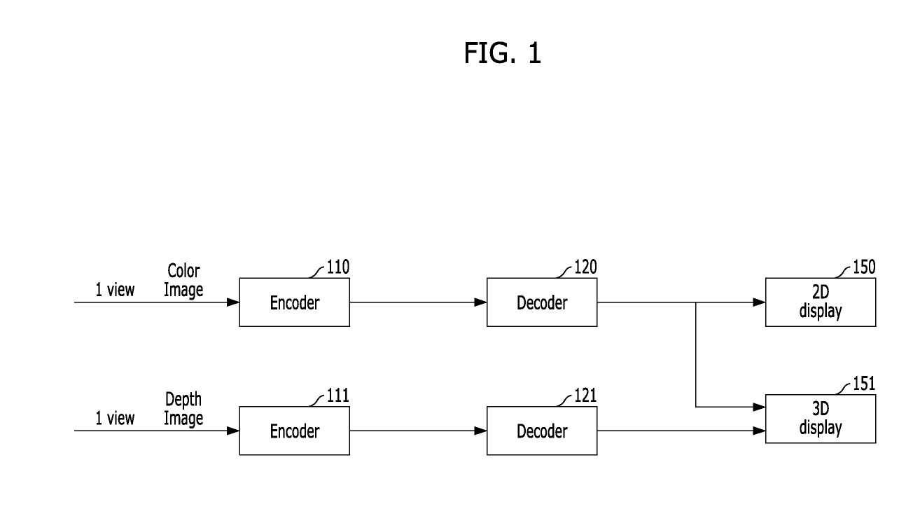

FIG. 1 illustrates components of an image display apparatus in an image system in accordance with an embodiment of the present invention.

Referring to FIG. 1, the image display apparatus includes encoders 110 and 111, decoders 120 and 121, a 2D display unit 150, and a 3D display unit 151. The image display apparatus can display 2D and 3D images. The encoders 110 and 111 are configured to receive color and depth images taken by a plurality of imaging devices of various types. As used herein, a depth image refers to an image having depth information, which refers to the distance to an object in the depth image from a specific viewpoint.

For example, a depth image can be described by a pixel value depending on the distance to an object in the depth image from a specific viewpoint. The closer to 0 the pixel value is, the nearer to black the color is; the closer to 255 the pixel value is, the nearer to white the color is. Specifically, the closer to white color an object in the depth image is, the nearer the object is from a specific viewpoint; the closer to black color, the farther the object is from the specific viewpoint.

The decoder 120 is configured to decode the encoded color image, and the 2D display unit 150 is configured to display the decoded color image. The decoder 121 is configured to decode the encoded depth image. The 3D display unit 151 is configured to apply DIBR (Depth Image Based Rendering) to the depth image decoded by the decoder 121 and the color image decoded by the decoder 120 to generate a 3D image.

That is, the DIBR refers to a method of implementing a 3D video service using reference and depth images. Specifically, an image and a depth map corresponding thereto are used for the receiving side to generate virtual left and right images and provide the watcher with depth perception. As used herein, the depth map refers to a map indicating the distance to an object in a depth image from a specific viewpoint.

An apparatus for providing a video service using the DIBR uses a very small amount of transmission, because, compared with conventional 3D image services using two color images, one color image and a depth image are used. Furthermore, terminals can provide 3D images by adding depth information to images broadcasted in the conventional manner, maintaining backward compatibility with systems currently in service. This enables switching between 2D and 3D services by the user's choice.

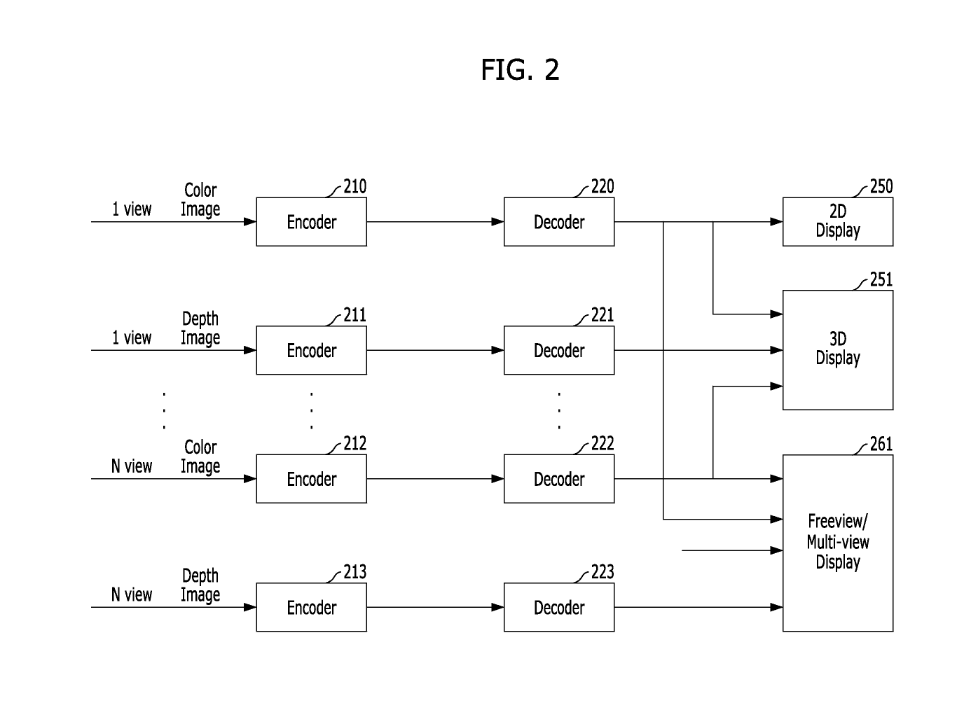

The 3D image display unit 151 can generate 3D images by applying not only the DIBR, but also other rending methods, to the depth image decoded by the decoder 121 and the color image decoded by the decoder 120. Components of an image display apparatus in an image system in accordance with another embodiment of the present invention will now be described in more detail with reference to FIG. 2.

FIG. 2 illustrates an image display apparatus in an image system in accordance with another embodiment of the present invention.

Referring to FIG. 2, the image display apparatus includes encoders 210, 211, . . . , 212, 213, decoders 220, 221, . . . , 222, 223, a 2D display unit 250, a 3D display unit 251, and a multi-view/free-view image display unit 252.

The image data display apparatus can display 2D images, 3D images, multi-view images, and free-view images. The encoders 210, 211, . . . , 212, 213 are configured to receive color and depth images taken by a plurality of imaging devices of various types. The number of encoders and decoders is determined based on the number of viewpoints from which images are been taken by the plurality of imaging devices.

The encoders 210, 211, . . . , 212, 213 are configured to encode the color and depth images, respectively, and the decoders 220, 221, . . . , 223, 223 are configured to decode the encoded color and depth images, respectively. The 2D display unit 250 is configured to display the decoded color image. The 3D display unit 251 is configured to generate a 3D image by applying DIBR to color and depth images of least one view.

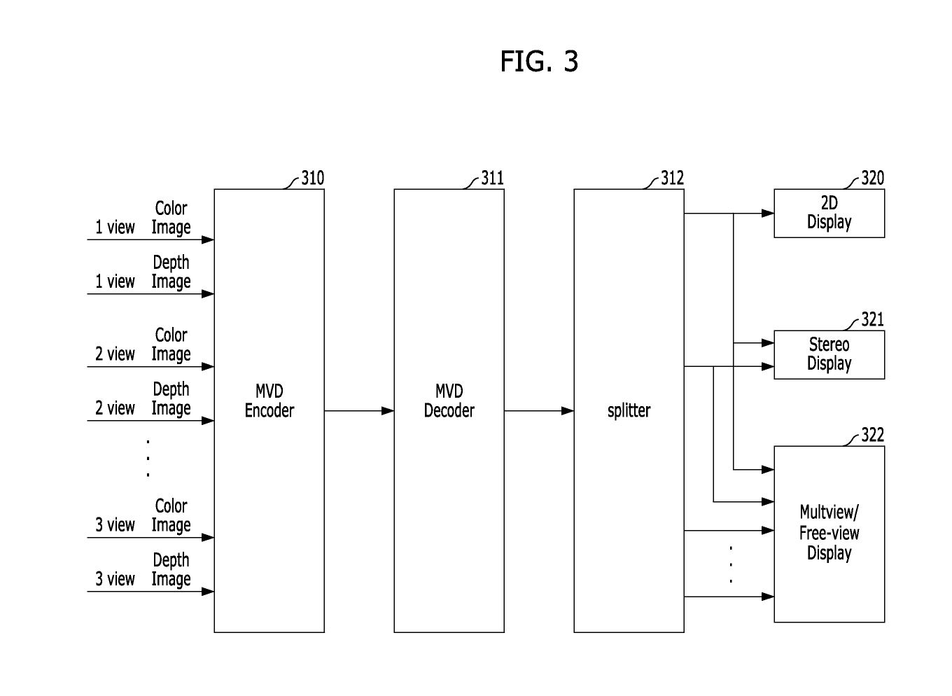

The DIBR has already been described, and repeated description thereof will be omitted herein. Other rendering methods than the DIBR can be applied to generate 3D images. The multi-view/free-view image display unit 252 is configured to display multi-view and free-view images using a color image of at least one view and depth information of at least one view. Components of an image display apparatus in an image system in accordance with still another embodiment of the present invention will now be described in more detail with reference to FIG. 3.

FIG. 3 illustrates the structure of an image display apparatus in an image system in accordance with still another embodiment of the present invention.

Referring to FIG. 3, the image data display apparatus includes a MVD encoder 310, a MVD decoder 311, a splitter 312, a 2D display unit 320, a 3D display unit 321, and a multi-view/free-view image display unit 322. The image data display apparatus can display 2D images, 3D images, multi-view images, and free-view images.

The MVD encoder 310 is configured to receive color and depth images of at least one view and encode the received color and depth images of at least view to output a bit stream. In this case, N of FIG. 3 refers to the number of views. The MVD decoder 320 is configured to decode the bit stream outputted from the MVD encoder 310.

The splitter 312 is configured to divide the decoded bit stream based on each view and image information and split it into color and depth images. The splitter 312 is configured to transmit the color and depth images, which have been split based on each view, to the 2D display unit 320, the 3D display unit 321, and the multi-view/free-view image display unit 322, respectively.

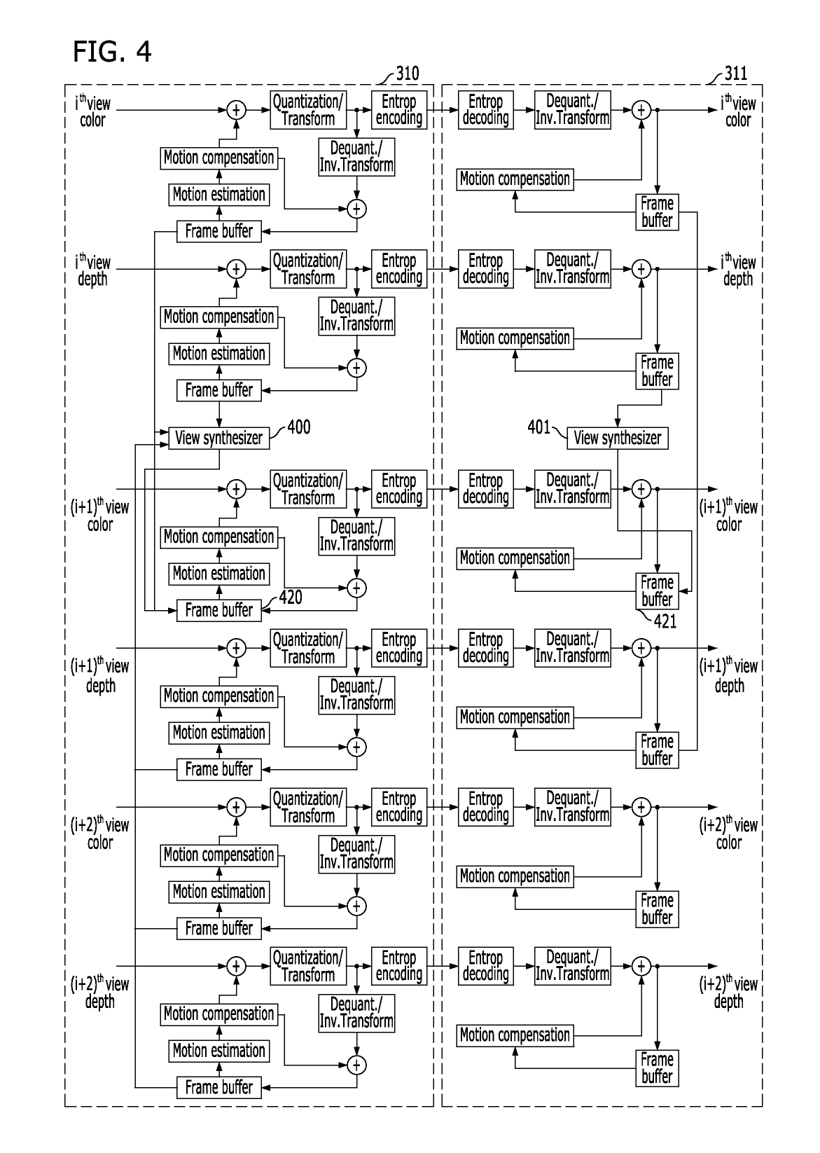

The 2D display unit 320 is configured to receive only the color image from the splitter 312 and display a 2D image. The 3D display unit 321 is configured to receive the color and depth images from the splitter 312 and display a 3D image. The multi-view/free-view image display unit 322 is configured to receive color and depth images of multiple views from the splitter 312 and display multi-view and free-view images. The internal structure of a MVD encoder 310 and a MVD decoder 311 of an image display apparatus in an image system in accordance with an embodiment of the present invention will now be described in more detail with reference to FIG. 4.

FIG. 4 illustrates the internal structure of a MVD encoder 310 and a MVD decoder 311 of an image display apparatus in an image system in accordance with an embodiment of the present invention.

Referring to FIG. 4, the MVD encoder 310 has a view synthesizer 400 configured to receive encoded color and depth images of i^{th} view, encoded color and depth images of (i+2)^{th} view, and encoded color and depth images of (i+1)^{th} view. It will be assumed in the following description that the image display apparatus in accordance with the present invention is in the process of encoding and decoding the encoded color image of (i+1)^{th} view.

It will be assumed first that the image display apparatus in accordance with the present invention is in the process of decoding the encoded color image of (i+1)^{th} view. The view synthesizer 400 synthesizes encoded color and depth images of i^{th} view, encoded color and depth images of (i+2)^{th} view, and a depth image of (i+1)^{th} view to be similar to the color image of (i+1)^{th} view. In this case, the view synthesizer 400 synthesizes color and depth images of multiple views using depth images of multiple views and a warping function. The image synthesized by the view synthesizer 400 corresponds to an image of an intermediate view. The image synthesized by the view synthesizer 400 is stored in a frame buffer 420.

During decoding of the color image of (i+1)^{th} view, the decoding efficiency improves in proportion to the number of reference images, e.g. images of multiple views, and the degree of similarity between the reference images and the color image of (i+1)^{th} view. For this reason, during decoding of the color image of (i+1)^{th} view, the synthesized image stored in the frame buffer 420 is referred to.

It will now be assumed in the following description that the image display apparatus in accordance with the present invention is in the process of encoding a decoded color image of (i+1)^{th} view. The view synthesizer 401 of the MVD decoder 311 receives decoded color and depth images of i^{th} view, decoded color and depth images of (i+2)^{th} view, and decoded depth and color images of (i+1)^{th} view.

The view synthesizer 401 synthesizes the decoded color and depth images of i^{th} view, the decoded color and depth images of (i+2)^{th} view, and the decoded depth image of (i+1)^{th} view to be similar to the color image of (i+1)^{th} view. In this case, the view synthesizer 401 synthesizes color and depth images of multiple views using depth images of multiple views and a warping function. The image synthesized by the view synthesizer 401 corresponds to an image of an intermediate view. The image synthesized by the view synthesizer 401 is stored in a frame buffer 421.

During encoding of the color image of (i+1)^{th} view, the encoding efficiency improves in proportion to the number of reference images, e.g. images of multiple views, and the degree of similarity between the reference images and the color image of (i+1)^{th} view. For this reason, during encoding of the color image of (i+1)^{th} view, the synthesized image stored in the frame buffer 421 is referred to.

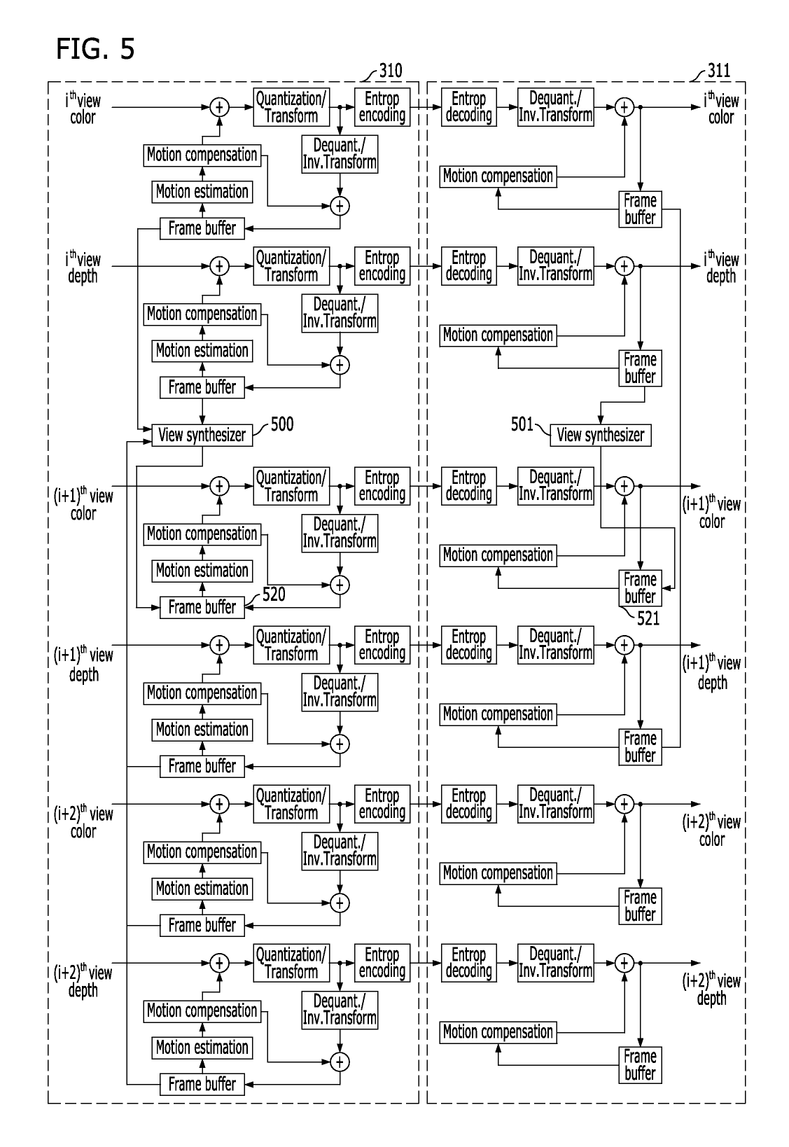

However, such synthesis of color and depth images of peripheral views and a depth image of the current view and use of the synthesized image as a reference image during encoding/decoding of the color image of the current view have a problem in that, during encoding/decoding of the color image of (i+1)^{th} view, a delay occurs between the depth and color images of (i+1)^{th} view. For this reason, a reference image can be generated by synthesizing encoded color and depth images of i^{th} view and encoded color and depth images of (i+2)^{th} view. The internal structure of a MVD encoder 310 and a MVD decoder 311 of an image display apparatus in an image system in accordance with another embodiment of the present invention will now be described in more detail with reference to FIG. 5.

FIG. 5 illustrates the internal structure of a MVD encoder 310 and a MVD decoder 311 of an image display apparatus in an image system in accordance with another embodiment of the present invention.

Referring to FIG. 5, the MVD encoder 310 has a view synthesizer 500 configured to receive encoded color and depth images of i^{th} view, encoded color and depth images of (i+2)^{th} view, and encoded color and depth images of (i+1)^{th} view. It will be assumed in the following description that the image display apparatus in accordance with the present invention is in the process of encoding and decoding the encoded color image of (i+1)^{th} view.

It will be assumed first that the image display apparatus in accordance with the present invention is in the process of decoding the encoded color image of (i+1)^{th} view. The view synthesizer 500 synthesizes the encoded color and depth images of i^{th} view and the encoded color and depth images of (i+2)^{th} view to be similar to the color image of (i+1)^{th} view. In this case, the view synthesizer 500 synthesizes color and depth images of multiple views using depth images of multiple views and a warping function. The image synthesized by the view synthesizer 500 corresponds to an image of an intermediate view. The image synthesized by the view synthesizer 500 is stored in a frame buffer 520.

During decoding of the color image of (i+1)^{th} view, the decoding efficiency improves in proportion to the number of reference images, e.g. images of multiple views, and the degree of similarity between the reference images and the color image of (i+1)^{th} view. For this reason, during decoding of the color image of (i+1)^{th} view, the synthesized image stored in the frame buffer 520 is referred to.

It will now be assumed in the following description that the image display apparatus in accordance with the present invention is in the process of encoding a decoded color image of (i+1)^{th} view. The view synthesizer 501 of the MVD decoder 311 receives decoded color and depth images of i^{th} view, decoded color and depth images of (i+2)^{th} view, and decoded color and depth images of (i+1)^{th} view.

The view synthesizer 501 synthesizes the decoded color and depth images of i^{th} view and the decoded color and depth images of (i+2)^{th} view to be similar to the color image of (i+1)^{th} view. In this case, the view synthesizer 501 synthesizes color and depth images of multiple views using depth images of multiple views and a warping function. The image synthesized by the view synthesizer 501 corresponds to an image of an intermediate view. The image synthesized by the view synthesizer 501 is stored in a frame buffer 521.

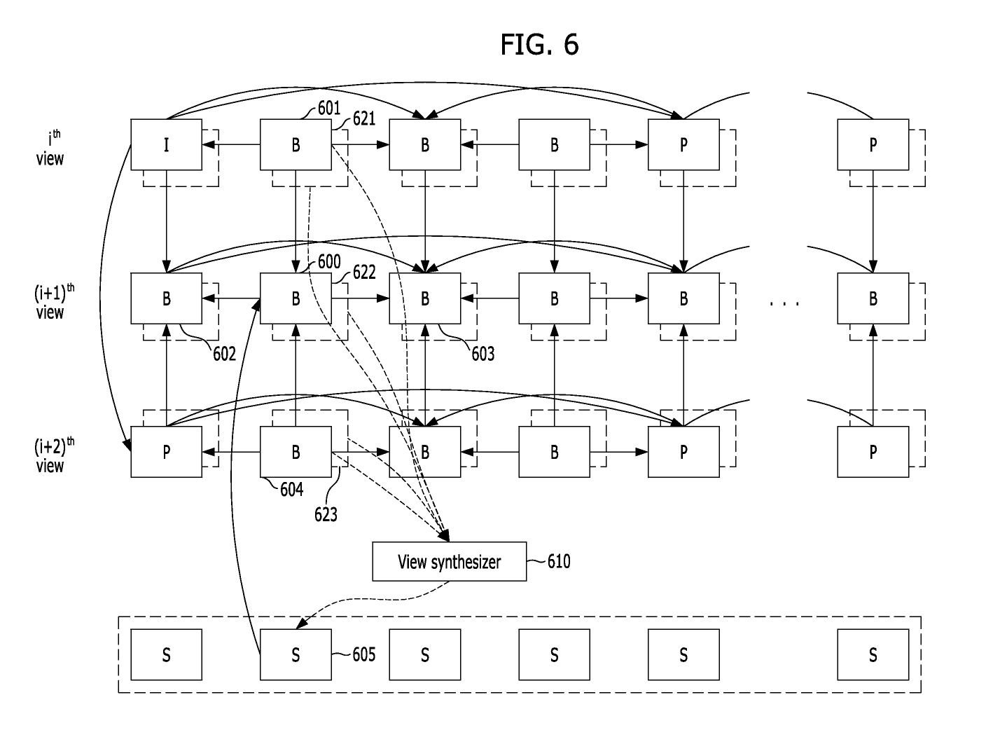

During encoding of the color image of (i+1)^{th} view, the encoding efficiency improves in proportion to the number of reference images, e.g. images of multiple views, and the degree of similarity between the reference images and the color image of (i+1)^{th} view. For this reason, during encoding of the color image of (i+1)^{th} view, the synthesized image stored in the frame buffer 521 is referred to. A reference structure during encoding based on the embodiment of FIG. 4 by a MVD encoder 310 of an image display apparatus in an image system in accordance with an embodiment of the present invention will now be described in more detail with reference to FIG. 6.

FIG. 6 illustrates a reference structure during encoding based on the embodiment of FIG. 4 by a MVD encoder 310 of an image display apparatus in an image system in accordance with an embodiment of the present invention.

Exemplary encoding of a color image 600 of (i+1)^{th} view will now be described with reference to the drawing, and this embodiment is extended and applied to other encoded images. Referring to FIG. 6, the MVD encoder 310 receives color and depth images of at least one view and encodes them. Among the received images, an image of a specific view consists of low-resolution frames, e.g. I, B, P. The view synthesizer 610 synthesizes color and depth images 601 and 621 of i^{th} view, color and depth images 604 and 623 of (i+2)^{th} view, and a depth image 622 of (i+1)^{th} view to be similar to a color image 600 of (i+1)^{th} view.

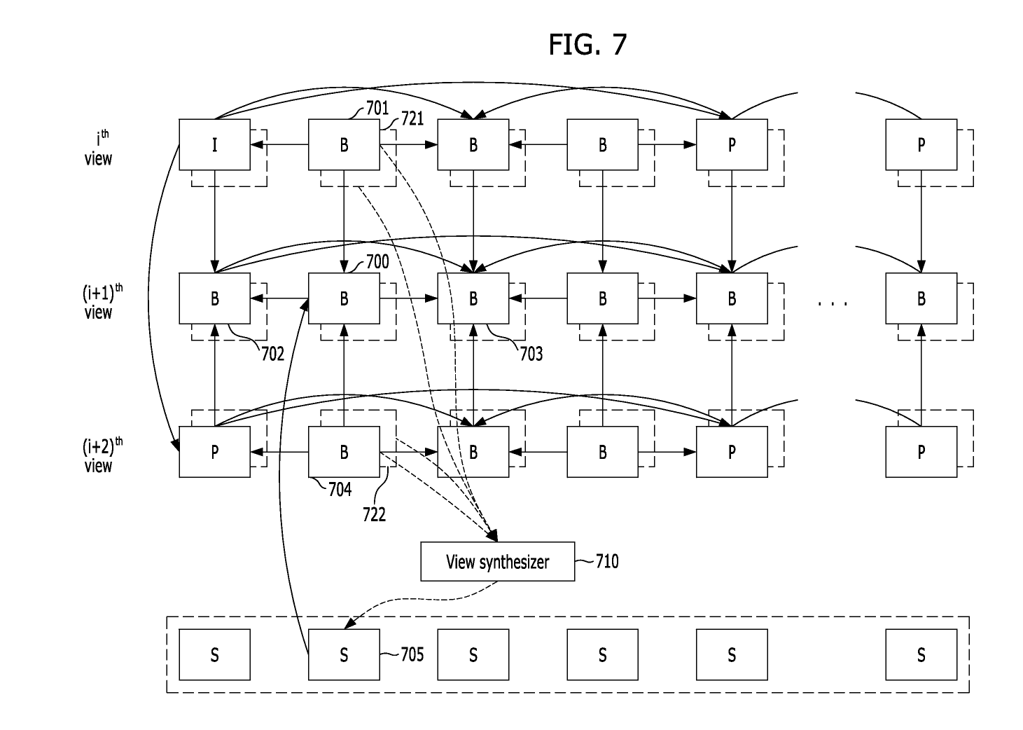

In this case, the view synthesizer 610 synthesizes color and depth images of multiple views using depth images of multiple views and a warping function. The MVD decoder 311 decodes the (i+1)^{th} frame B 600 by using a frame B 601 of i^{th} view, frames B 602 and 603 of (i+1)^{th} view, a frame B 604 of (i+2)^{th} view, and the synthesized image 605. Exemplary encoding of a color image 600 of (i+1)^{th} view will now be described with reference to the drawing, and this embodiment is extended and applied to other encoded images. A reference structure during encoding based on the embodiment of FIG. 5 by a MVD encoder 310 of an image display apparatus in an image system in accordance with an embodiment of the present invention will now be described in more detail with reference to FIG. 7.

FIG. 7 illustrates a reference structure during encoding based on the embodiment of FIG. 5 by a MVD encoder 310 of an image display apparatus in an image system in accordance with an embodiment of the present invention.

Referring to FIG. 7, the MVD encoder 310 receives color and depth images of at least one view and encodes them. Among the received images, an image of a specific view consists of low-resolution frames, e.g. I, B, P. The view synthesizer 710 generates a reference image 705 by synthesizing color and depth images 701 and 721 of i^{th} view and color and depth images 704 and 722 of (i+2)^{th} view to be similar to a color image 700 of (i+1)^{th} view.

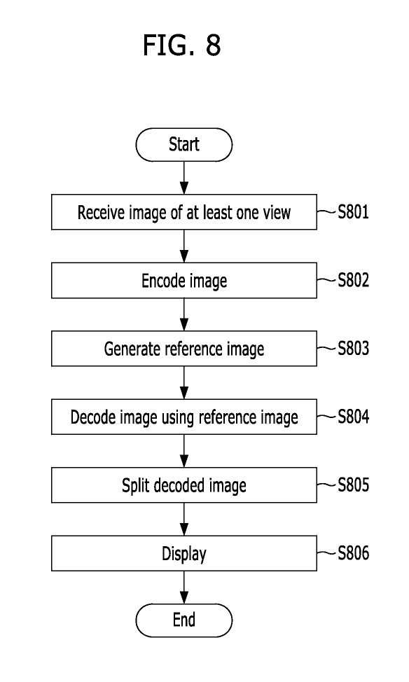

In this case, the view synthesizer 710 synthesizes color and depth images of multiple views using depth images of multiple views and a warping function. The MVD decoder 311 decodes the (i+1)^{th} frame B 700 by using a frame B 701 of i^{th} view, frames B 702 and 703 of (i+1)^{th} view, a frame B 704 of (i+2)^{th} view, and the synthesized image 705. A method for displaying images in an image system in accordance with an embodiment of the present invention will now be described in more detail with reference to FIG. 8.

FIG. 8 illustrates an image display process in an image system in accordance with an embodiment of the present invention.

Referring to FIG. 8, the MVD encoder 310 receives color and depth images of at least one view at step S801. The MVD encoder 310 encodes the received color and depth images of at least one view and output a bit stream at step S802. The MVD encoder 310 synthesizes a reference image by synthesizing an encoded depth image of the current view and encoded color and depth images before and after the current view according to a predetermined method at step S803. In this case, the view synthesizer 400 can synthesize color and depth images of multiple views using depth images of multiple views and a warping function, and the MVD encoder 310 can synthesize a reference image using encoded color and depth images before and after the current view.

The MVD decoder 311 decodes a color image of the current view using the generated reference image at step S804. The MVD decoder 311 can generate a reference image by synthesizing a decoded depth image of the current view and decoded color and depth images before and after the current view according to a predetermined method, and the MVD encoder 310 can encode the color image of the current view using the generated reference image.

The splitter 312 divides the decoded bit stream based on each view and image information and splits it into color and depth images at step S805. The 2D display unit 320 receives only the color image from the splitter 312 and displays a 2D image at step S806. The 3D display unit 321 receives the color and depth images from the splitter 312 and displays a 3D image at step S806. The multi-view/free-view image display unit 322 receives color and depth images of multiple views from the splitter 312 and displays multi-view and free-view images at step S806.

In accordance with the exemplary embodiments of the present invention, 2D and 3D images can be displayed, and color and depth images of peripheral views and a depth image of the current view are synthesized and encoded/decoded to be used as a reference image during encoding of a color image of the current view.

While the present invention has been described with respect to the specific embodiments, it will be apparent to those skilled in the art that various changes and modifications may be made without departing from the spirit and scope of the invention as defined in the following claims.

What is claimed is:

1. An apparatus for displaying images, comprising:
an encoder configured to encode color and depth images of at least one view received from a plurality of imaging devices and generate a reference image by synthesizing the encoded depth image of a current view and the encoded color and depth images before and after the current view based on a predetermined method;
a decoder configured to decode a color image of the current view by using the generated reference image and decode the encoded color and depth images of at least one view; and
a splitter configured to divide and split, based on each view, the decoded color and depth images of at least one view.

2. The apparatus of claim 1, further comprising a first display unit configured to receive and display the split color image.

3. The apparatus of claim 1, further comprising a second display unit configured to render the split color and depth images in a predetermined scheme and display the rendered images.

4. The apparatus of claim 1, further comprising a third display unit configured to render the slit color and depth images of at least one view in a predetermined scheme and display the rendered images.

5. The apparatus of claim 1, wherein the decoder further comprises a view generation unit configured to generate a reference image by synthesizing the decoded depth image of the current view and the decoded color and depth images before and after the current view based on a predetermined method.

6. The apparatus of claim 5, wherein the view generation unit is configured to generate a reference image by synthesizing the decoded color and depth images before and after the current view based on a predetermined method.

7. The apparatus of claim 1, wherein the encoder is configured to encode the color image of the current view using the reference image.

8. The apparatus of claim 1, wherein the encoder is configured to generate a reference image by synthesizing the encoded color and depth images before and after the current view based on a predetermined method.

9. The apparatus of claim 1, wherein the reference image is generated by synthesizing color and depth images of multiple views using a depth image of at least one view and a warping function.

10. A method for displaying images, comprising:
encoding color and depth images of at least one view received from a plurality of imaging devices;
generating a reference image by synthesizing the encoded depth image of a current view and the encoded color and depth images before and after the current view based on a predetermined method;
decoding a color image of the current view by using the generated reference image and decoding the encoded color and depth images of at least one view; and
dividing and splitting, based on each view, the decoded color and depth images of at least one view.

11. The method of claim 10, further comprising:
receiving and displaying the split color image.

12. The method of claim 10, further comprising:
rendering the split color and depth images in a predetermined scheme and displaying the rendered images.

13. The method of claim 10, further comprising:
rendering the slit color and depth images of at least one view in a predetermined scheme and displaying the rendered images.

14. The method of claim 10, wherein said decoding a color image of the current view by using the generated reference image and decoding the encoded color and depth images of at least one view further comprises:
generating a reference image by synthesizing the decoded depth image of the current view and the decoded color and depth images before and after the current view based on a predetermined method.

15. The method of claim 14, wherein in said generating a reference image by synthesizing the decoded depth image of the current view and the decoded color and depth images before and after the current view based on a predetermined method,
a reference image is generated by synthesizing the decoded color and depth images before and after the current view based on a predetermined method.

16. The method of claim 10, wherein in said encoding color and depth images of at least one view received from a plurality of imaging devices,
the color image of the current view is encoded using the reference image.

17. The method of claim 10, wherein in said generating a reference image by synthesizing the encoded depth image of a current view and the encoded color and depth images before and after the current view based on a predetermined method,
a reference image is generated by synthesizing the encoded color and depth images before and after the current view based on a predetermined method.

18. The method of claim 10, wherein the reference image is generated by synthesizing color and depth images of multiple views using a depth image of at least one view and a warping function.
